(19) United States
(12) Patent Application Publication
(10) Pub. No.: US 2026/0193835 A1
(43) Pub. Date: Jul. 9, 2026

(54) WATER STRIPPING METHOD, WATER STRIPPING DEVICE, AND WATER STRIPPING SYSTEM OF LEATHER FIBER

(71) Applicant: Hangzhou Sun-Tech Co., Ltd., Zhejiang (CN)

(72) Inventors: Wei SUN, Zhejiang (CN); Shen FENG, Zhejiang (CN); Yuanshuang LU, Zhejiang (CN)

(21) Appl. No.: 19/010,289

(22) Filed: Jan. 6, 2025

(51) Int. Cl. D06M 16/00; B09B 3/60; B09B 3/70; D06B 3/20; D06M 101/14

(52) U.S. Cl. CPC D06M 16/003; B09B 3/60; B09B 3/70; D06B 3/208; D06M 2101/14; D10B 2211/06

(57) ABSTRACT

A water stripping method, a water stripping device, and a water stripping system of a leather fiber are provided, relating to the technical field of leather recycling. Since a leather fiber in a waste leather is easier to be physically opened and impact-stripped than a coating layer, the waste leather with the coating layer can be initially treated by stripping, such that the leather fiber is effectively stripped from the coating layer. This process avoids the problem that the leather fiber and the coating layer cannot be separated due to adhesion, and even if the leather fiber and the coating layer are separated, broken leather fibers may still be doped with some coating layer fragments. Moreover, the process effectively improves an initial treatment effect of the waste leather and a leather fiber recovery rate, thereby improving a recycling rate of the waste leather with the coating layer.

### TECHNICAL FIELD

The present disclosure relates to the technical field of leather recycling, and in particular to a water stripping method, a water stripping device, and a water stripping system of a leather fiber.

### BACKGROUND

Recycled leather can achieve resource recycling and environmental protection, and is currently widely used in leather products. Recycled leather is mainly reused from old leather products, and not less than 90% of waste leather in the recycled old leather products contain coating layers such as polyurethane (PU) layers.

For waste leather with a coating layer, leather fibers adhering to the coating layer are mainly recycled excluding the coating layer itself. At present, mechanical shredding is mainly adopted for the initial treatment of waste leather with a coating layer, with the following disadvantages:
(I) The coating layer in the waste leather is adhered to the leather fibers to be recycled. After mechanical shredding, some leather fibers cannot be completely separated from the coating layer, resulting in a low and unstable recycling rate of the waste leather.
(II) Since the coating layer is also mechanically shredded, even if the leather fibers and the coating layer are structurally separated after shredding, a part of the shredded coating layer can still become impurities mixed in the shredded leather fibers and cannot be effectively separated. These tiny leather fibers with impurities cannot be used as a raw material for recycled leather, which also reduces the recycling rate of waste leather.
(III) A large amount of tiny powder can be generated during the mechanical shredding of waste leather, not only leading to an extremely harsh working environment but also posing a safety risk of explosion and flammability.

In summary, the existing initial treatment processes for waste leather with a coating layer not only show a low recycling rate of waste leather, but also have safety risks of being explosive and flammable. So far, there is a large inventory of the waste leather with a coating layer in the entire market. The existing initial treatment of waste leather by mechanical shredding has greatly restricted the recycling of waste leather and cannot be promoted.

### SUMMARY

An objective of the present disclosure is to propose a water stripping method, a water stripping device, and a water stripping system of a leather fiber. The water stripping method can conduct initial treatment on the waste leather with a coating layer by stripping, such that a leather fiber can be effectively stripped from the coating layer. This method not only improves a leather fiber recovery rate, but also has a safe and dust-free working environment, thereby solving the problems of low waste leather recycling rate, as well as high safety risks being explosive and flammable in the prior art.

To achieve the above objective, the present disclosure provides the following technical solutions:
(I) The present disclosure provides a water stripping method of a leather fiber, including the following steps:
   S1, immersing a waste leather with a coating layer in a chemical solution to achieve preliminary immersing and softening of a leather fiber of the waste leather; and
   S2, immersing the waste leather after the preliminary immersing and softening in a container filled with a liquid, and applying at least one selected from the group consisting of a water flow, a gas flow, and a mechanical wave to the liquid in the container, such that the liquid in the container impacts the waste leather after the preliminary immersing and softening and then strips the leather fiber on the coating layer of the waste leather.

In an embodiment, the chemical solution is at 20° C. to 80° C., the waste leather is immersed in the chemical solution for a time t greater than or equal to 1 h and less than or equal to 24 h, and a concentration K of the waste leather in the chemical solution is less than or equal to 300 kg/cubic meter of the chemical solution in step S1.

In an embodiment, the chemical solution includes water and a biological protease, and the chemical solution has a pH value of 2 to 11.

In an embodiment, the biological protease is at least one selected from the group consisting of a serine protease and an alkaline protease.

In an embodiment, the liquid is selected from the group consisting of water and the chemical solution.

In an embodiment, when the gas flow is applied to the liquid in the container, the gas flow has a pressure of 0.2 MPa to 2 MPa.

In an embodiment, when the water flow is applied to the liquid in the container, the water flow has a pressure of 20 MPa to 200 MPa.

In an embodiment, when the mechanical wave is applied to the liquid in the container, the mechanical wave has a frequency of 25 kHz to 50 kHz.
(II) The present disclosure further provides a water stripping device of a leather fiber, including:
   a stripping container, where the stripping container contains a liquid, and the liquid is configured to immerse a waste leather with a coating layer; and
   a liquid vibration device arranged on the stripping container and immersed in the liquid, where the liquid vibration device is configured to apply at least one selected from the group consisting of a water flow, a gas flow, and a mechanical wave to the liquid in the stripping container, such that the liquid impacts the waste leather and then strips a leather fiber of the waste leather on the coating layer of the waste leather.

In an embodiment, the liquid vibration device includes a water jet, the water jet is arranged in the stripping container, the water jet is configured to spray the water flow into the liquid, and a jet direction of the water flow has an included angle of less than 90° with a liquid surface of the liquid to promote a directional flow of the liquid in the stripping container while vibrating the liquid.

In an embodiment, the water jet is connected to an external water source via a high-pressure water pump; alternatively, the water jet is connected to the stripping container via the high-pressure water pump and a liquid filtration device; the liquid filtration device is configured to filter the liquid in the stripping container, and the high-pressure water pump is configured to pump a resulting filtered liquid to the water jet, thereby achieving cyclic injection of the liquid.

In an embodiment, the liquid vibration device includes a gas jet, the gas jet is arranged in the stripping container, the gas jet is configured to spray the gas flow into the liquid, and a jet direction of the gas flow has an included angle of less than 90° with a liquid surface of the liquid to promote a directional flow of the liquid in the stripping container while vibrating the liquid.

In an embodiment, the gas jet is externally connected to a high-pressure gas source.

In an embodiment, a liquid circulation pressurizing pipe is arranged in the stripping container along a direction of the directional flow of the liquid, and the liquid circulation pressurizing pipe is immersed in the liquid; and the liquid vibration device is embedded in a side wall of the liquid circulation pressurizing pipe, or arranged in the liquid circulation pressurizing pipe, or arranged in front of a liquid inlet end of the liquid circulation pressurizing pipe, and the liquid inlet end is in a bell-mouth shape.

In an embodiment, a liquid outlet end of the liquid circulation pressurizing pipe is in a bell-mouth shape.

In an embodiment, the liquid vibration device includes a mechanical wave transmitter and a liquid flow driving device, the mechanical wave transmitter and the liquid flow driving device each are arranged in the stripping container, the mechanical wave transmitter is configured to spray the mechanical wave into the liquid to make the liquid vibrate, and the liquid flow driving device is configured to drive a directional flow of the liquid in the stripping container while the liquid vibrates.

In an embodiment, the liquid flow driving device includes at least one of a gas jet and a water jet; when the liquid flow driving device includes the gas jet, the gas jet is arranged in the stripping container, the gas jet is configured to spray the gas flow into the liquid, and a jet direction of the gas flow has an included angle of less than 90° with a liquid surface of the liquid; and when the liquid flow driving device includes the water jet, the water jet is arranged in the stripping container, the water jet is configured to spray the water flow into the liquid, and a jet direction of the water flow has an included angle of less than 90° with the liquid surface of the liquid.

In an embodiment, the mechanical wave transmitter is an ultrasonic wave transmitting device.

In an embodiment, the ultrasonic wave transmitting device includes multiple ultrasonic wave transmitting units, and any one of the multiple ultrasonic wave transmitting units includes:
an ultrasonic wave generator arranged on an outer side wall of the stripping container; and
a vibration device including an amplitude transformer and a vibrating arm, where the vibrating arm is arranged in the stripping container and immersed in the liquid, an end of the vibrating arm is connected to the ultrasonic wave generator through the amplitude transformer, and multiple protrusion structures are arranged on the vibrating arm.

In an embodiment, the stripping container is selected from the group consisting of an annular flume, a multi-cambered flume, and a straight flume.
(III) The present disclosure further provides a water stripping system of a leather fiber, including a filtration device and the water stripping device of a leather fiber, where the filtration device is configured to filter the leather fiber stripped from the stripping container.

The present disclosure achieves the following technical effects over the prior art:
The water stripping method, water stripping device, and water stripping system of a leather fiber proposed in the present disclosure mainly have the following beneficial effects compared with the prior art:
I. A novel initial treatment scheme for waste leather based on a combination of chemical solution immersion and liquid immersion stripping is proposed, and has a simpler process flow. Since a leather fiber in a waste leather is easier to be physically opened and impact-stripped than a coating layer, the waste leather with the coating layer can be initially treated by stripping, such that the leather fiber is effectively stripped from the coating layer. This process avoids the problem that the leather fiber and the coating layer cannot be separated due to adhesion, and even if the leather fiber and the coating layer are separated, broken leather fibers may still be doped with some coating layer fragments. Moreover, the process effectively improves an initial treatment effect of the waste leather, a recovery quality, and a leather fiber recovery rate, thereby improving a recycling rate of the waste leather with a coating layer and solving the problem of low recycling rate of the waste leather with a coating layer in the current market.
II. Both the chemical solution immersion and liquid immersion stripping are conducted by immersing the waste leather in liquid. A working process is dust-free, and a working environment is safer and more environmental-friendly, thus avoiding the high safety risks such as explosion and flammability in the existing treatment of waste leather by mechanical shredding.
III. This method can effectively strip the leather fiber without damaging the coating layer or with minimal damage, and is conducive to separated filtering and sorting of the coating layer and/or leather fiber after stripping to allow special treatment.

### BRIEF DESCRIPTION OF THE DRAWINGS

To describe the technical solutions in examples of the present disclosure or in the prior art more clearly, the accompanying drawings required for the examples are briefly described below. Apparently, the accompanying drawings in the following description show merely some examples of the present disclosure, and those of ordinary skill in the art may still derive other accompanying drawings from these accompanying drawings without creative efforts.

FIG. 1 shows a flow chart of the water stripping method of a leather fiber disclosed in Example 1 of the present disclosure;

FIG. 2 shows an overall structural diagram of the water stripping device of a leather fiber disclosed in Example 2 of the present disclosure;

FIG. 3 shows a top view of the stripping container disclosed in Example 2 of the present disclosure;

FIG. 4 shows an enlarged view of A in FIG. 3;

FIG. 5 shows a schematic structural diagram of the liquid circulation pressurizing pipe disclosed in Example 2 of the present disclosure;

FIG. 6 shows a schematic structural diagram of the annular flume disclosed in Example 2 of the present disclosure;

FIG. 7 shows the structural arrangement for three groups of the water jets disclosed in Example 2 of the present disclosure;

FIG. 8 shows the structural arrangement for two groups of the water jets disclosed in Example 2 of the present disclosure;

FIG. 9 shows the structural arrangement for five groups of the water jets disclosed in Example 2 of the present disclosure;

FIG. 10 shows an overall structural diagram of the water stripping device of a leather fiber disclosed in Example 3 of the present disclosure;

FIG. 11 shows a schematic structural diagram of the ultrasonic wave transmitting device in the water stripping device of a leather fiber disclosed in Example 4 of the present disclosure;

FIG. 12 shows a section view along B-B in FIG. 11;

FIG. 13 shows a schematic structural diagram of the square annular flume disclosed in Example 5 of the present disclosure;

FIG. 14 shows a schematic structural diagram of the multi-cambered flume disclosed in Example 6 of the present disclosure;

FIG. 15 shows a schematic structural diagram of the straight flume with reciprocating liquid flow disclosed in Example 7 of the present disclosure; and

FIG. 16 shows a schematic structural diagram of the straight flume with unidirectional liquid flow disclosed in Example 7 of the present disclosure.

In the figures, the reference numerals are:
100. Water stripping device of a leather fiber;
1. Stripping container; 11. L-shaped mounting plate; 12. Water tank with strainer; 13. Filter plate; 14. Annular flume; 15. Square annular flume; 16. Multi-cambered flume; 17. Straight flume;
2. Liquid circulation pressurizing pipe; 21. Middle section; 22. Liquid inlet end; 23. Liquid outlet end; 24. Extension plate; 25. Water passing zone; 26. Mounting groove;
3. Bolt;
4. Water jet; 41. Nozzle;
5. High-pressure water pump;
6. Liquid filtration device;
7. High-pressure gas source; 71. Air cannon; 72. Impulse valve; 73. Gas guide tube;
74. Gas storage tank; 75. Air compressor; and
8. Ultrasonic wave transmitting device; 81. Ultrasonic wave generator; 82. Amplitude transformer; 83. Vibrating arm; 84. Protrusion structure.

### DETAILED DESCRIPTION OF THE EMBODIMENTS

The technical solutions of the examples of the present disclosure are clearly and completely described below with reference to the drawings in the examples of the present disclosure. Apparently, the described examples are merely a part rather than all of the embodiments of the present disclosure. All other examples obtained by those skilled in the art based on the examples of the present disclosure without creative efforts shall fall within the protection scope of the present disclosure.

A first objective of the present disclosure is to propose a water stripping method of a leather fiber. The water stripping method can conduct initial treatment on the waste leather with a coating layer by stripping, such that a leather fiber can be effectively stripped from the coating layer. This method not only improves a leather fiber recovery rate, but also has a safe and dust-free working environment, thereby solving the problems of low waste leather recycling rate, as well as high safety risks being explosive and flammable in the prior art.

Another objective of the present disclosure is to propose a water stripping device of a leather fiber. The water stripping method can conduct initial treatment on the waste leather with a coating layer by stripping, such that a leather fiber can be effectively stripped from the coating layer. This method not only improves a leather fiber recovery rate, but also has a safe and dust-free working environment, thereby solving the problems of low waste leather recycling rate, as well as high safety risks being explosive and flammable in the prior art.

Another objective of the present disclosure is to propose a water stripping system of a leather fiber based on the water stripping device of a leather fiber, thereby solving the problems of low waste leather recycling rate, as well as high safety risks being explosive and flammable in the prior art.

To make the above objective, features, and advantages of the present disclosure clearer and more comprehensible, the present disclosure will be further described in detail below in conjunction with the accompanying drawings and specific examples.

### Example 1

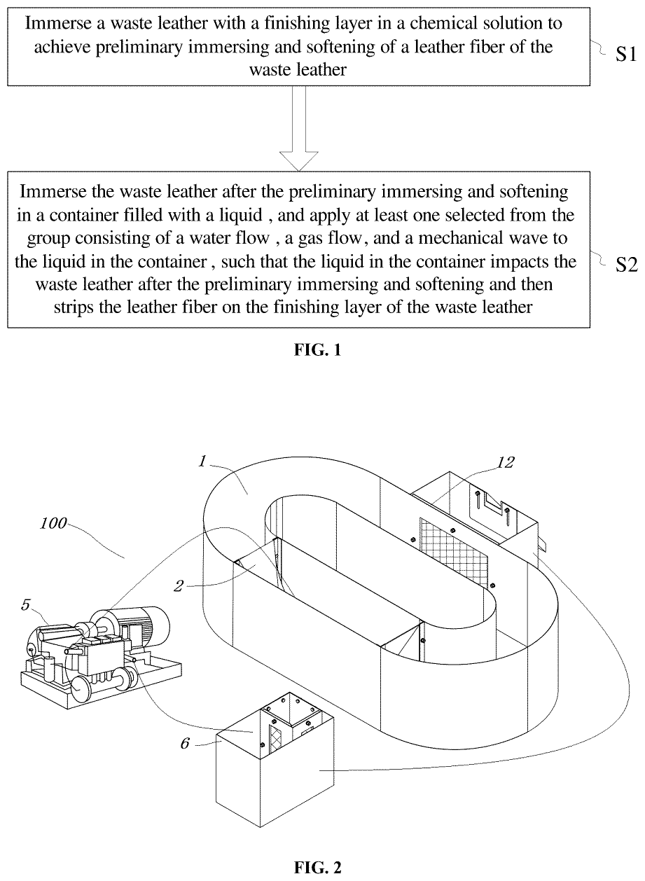

As shown in FIG. 1, this example provided a water stripping method of a leather fiber, including the following steps:
S1. A waste leather with a coating layer was immersed in a chemical solution such that a leather fiber of the waste leather was infiltrated with the chemical solution to achieve preliminary immersing and softening (this softening was a biochemical reaction); the chemical solution used could be a biological agent, such as a mixture of water and a biological protease. Generally, the chemical solution preferably had a pH value of 2 to 11, the chemical solution was at 20° C. to 80° C., and the waste leather was immersed in the chemical solution for 1 h≤t≤24 h, and a concentration of the waste leather in the chemical solution was K≤300 kg/cubic meter of the chemical solution.
S2. The waste leather after the preliminary immersing and softening in step S1 was immersed in a container filled with a liquid, and at least one selected from the group consisting of a water flow, a gas flow, and a mechanical wave was applied to the liquid in the container, such that the liquid in the container impacted the waste leather after the preliminary immersing and softening and then stripped the leather fiber on the coating layer of the waste leather, and then the leather fiber was further hydrolyzed into mutually dissociated fibers. Generally, the waste leather impacted by the liquid was mostly in the form of thin strips of fibers.

In the above scheme of this example, the waste leather after preliminary physical fiber opening was mainly submerged in the liquid of the container, and energy such as water flow, gas flow, and mechanical wave was applied to the liquid of the container. Thus, vibration of the liquid could produce liquid impact and liquid cutting effects on the leather fiber after physical fiber opening on the waste leather, so as to strip off the leather fiber from the coating layer of the waste leather, and efficiently dissociate the leather fiber, thereby finally obtaining qualified fine leather fibers. In most cases, the leather fiber was stripped off from the coating layer of the waste leather one by one and layer by layer, that is, the aforementioned fine leather fibers were mostly in the form of thin strips. The stripped leather fibers could float and diffuse in the water like cotton. Ideally, even if a large number of strip-shaped leather fibers had been separated from the waste leather, the waste leather still looked intact, but as a stripping amount of the leather fiber increased, the waste leather became thinner and softer overall. Alternatively, even if the coating layer was slightly damaged by the liquid vibration impact, it might be destroyed into a large structure that was much larger than the small leather fiber fragments, which could be clearly distinguished from the small leather fiber fragments and were easy to sort. Before submerging and dissociation, the waste leather was immersed in the chemical solution in step S1, which could promote the softening of the leather fiber on the waste leather based on promoting protein decomposition. However, this process had little effect on the coating layer, thereby reducing a bonding strength between the leather fibers and between the leather fiber and the coating layer, and then laying a foundation for the subsequent immersion, vibration, and stripping. Meanwhile, since the stripping was conducted by immersing in the liquid, the immersion of the liquid could promote the softening and fiber opening of the leather fiber on the waste leather to a certain extent, which helped to stably and efficiently strip the leather fiber from the coating layer.

In this example, a biological protease used in the chemical solution might specifically be a serine protease or an alkaline protease. The alkaline protease may specifically be Bacillus protease or subtilisin. The protease can decompose the macromolecular compounds in the leather fiber, thereby reducing the toughness and strength of the leather fiber, reducing the strength between the leather fibers, and facilitating the physical fiber opening of the leather fiber.

In step S2 of this example, the liquid might be water different from the chemical solution in step S1, or the chemical solution in step S1 might be used, or the chemical solution in step S1 might be directly continued to be used. Generally, the chemical solution immersion in step S1 was conducted in one container, and the immersion stripping in step S2 was also conducted in one container. Regardless of whether the liquid in step S2 was water or the chemical solution in step S1, an operator could conduct steps S1 and S2 in a same container or in different containers according to actual demands.

In step S2 of this example, one of water flow, gas flow, and mechanical wave might be applied to the container alone, or a combination of at least two of the water flow, gas flow, and mechanical wave might be applied to the container as needed. The water flow could be applied by installing a water jet in the container, the gas flow could be applied by installing a gas jet in the container, and the mechanical wave could be an ultrasonic wave applied by adding an ultrasonic wave generator in the container.

The following specifically described the water stripping method of a leather fiber in this example by taking the liquid in step S2 as water and applying a water flow to the liquid as an example.

Step S1, a chemical solution and a waste leather with a coating layer were added into a container, where the chemical solution needed to submerge the waste leather, and each cubic meter of the chemical solution had 10 kg to 300 kg of the waste leather, the chemical solution was at 20° C. to 50° C., the chemical solution had a concentration of 1 kg/cubic meter of water to 10 kg/cubic meter of water, and immersing lasted for 3 h to 24 h; the coating layer was generally made of PU, and the chemical solution did not have any effect on the coating layer.

Step S2, the waste leather after physical fiber opening was placed into a corresponding container, and a water jet was installed in the container and located underwater; the water jet generated a high-pressure water flow of 20 MPa to 200 MPa underwater, which could both vibrate the water and drive the water to flow in a directional manner in the container, thereby achieving dynamic stripping of the leather fiber. The directional flow direction of the water mainly depended on a shape of the container: if the container was annular, the water was driven to flow in an annular circulation; if the container was straight or curved, the water was driven to flow along the extension direction of the container, and so on.

The thin leather fibers stripped off by impact were sorted and collected to complete the separation and recovery of leather fibers on the waste leather with a coating layer.

In order to improve the stripping effect and efficiency of leather fiber, multiple water jets were preferably grouped as a whole together; a group of water jets was arranged in the container, or multiple groups of water jets were arranged at intervals along the directional flow direction of water; the water jets in any group of water jets were preferably arranged in an array.

While stripping the leather fiber with high-energy water, the directional flow of water could drive the waste leather and the leather fiber blocks that had been stripped to flow, such that the leather fiber was subjected to more uniform force. In this way, the waste leather and leather fiber blocks were prevented from staying at an installation position of the water jet and being overly impacted by the high-energy high-pressure water flow, thereby causing the stripped leather fiber blocks to have too small particle sizes, increasing damages to the coating layer, increasing impurities stripped, increasing the difficulty of sorting, and reducing the recycling efficiency.

In practical applications, in order to obtain a leather fiber that better met the requirements, a single treatment time of the waste leather in water could be extended, or a number of treatments of the leather fiber blocks could be increased (i.e., the stripped leather fiber was filtered out and then put back into the container to allow secondary water impact crushing).

After comparison, in the recycling of traditional recycled leather, the waste leather with a coating layer needs to be washed, cleaned, dried, and then mechanically shredded. Some leather fibers cannot be separated from the coating layer, or the stripped leather fiber is mixed with coating layer fragments and cannot be completely separated, resulting in a leather fiber recovery rate of less than 30%. In contrast, through steps S1 and S2 in this example, based on a same treatment time and a same amount of waste leather, the leather fiber recovery rate is not less than 70%. It should be noted that the chemical solution immersion in step S1 of this example is equivalent to a catalyst, which can accelerate the stripping of leather fiber. At the same time, it will also destroy the strength and toughness of the leather fiber to a certain extent, such that a small part of the stripped leather fibers still cannot meet the recycling standards. As a result, based on the same treatment time and the same amount of waste leather, the leather fiber recovery rate can generally exceed 90%.

It can be seen that the water stripping method of a leather fiber proposed in this example for the water stripping of leather fiber on the waste leather has the following beneficial effects compared with the prior art:
I. A novel initial treatment scheme for waste leather based on a combination of chemical solution immersion and liquid immersion stripping is proposed, and has a simpler process flow.
Since a leather fiber in a waste leather is easier to be physically opened and impact-stripped than a coating layer, the waste leather with the coating layer can be initially treated by stripping, such that the leather fiber is effectively stripped from the coating layer. This process avoids the problem that the leather fiber and the coating layer cannot be separated due to adhesion, and even if the leather fiber and the coating layer are separated, broken leather fibers may still be doped with some coating layer fragments. Moreover, the process effectively improves an initial treatment effect of the waste leather and a leather fiber recovery rate, thereby improving a recycling rate of the waste leather with a coating layer and solving the problem of low recycling rate of the waste leather with a coating layer in the current market, and finally expanding the raw material sources of the waste leather recycling industry by over ten times or even dozens of times.
II. Both the chemical solution immersion and liquid immersion stripping are conducted by immersing the waste leather in liquid. A working process is dust-free, and a working environment is safer and more environmental-friendly, thus avoiding the high safety risks such as explosion and flammability in the existing treatment of waste leather by mechanical shredding.
III. This method can effectively strip the leather fiber without damaging the coating layer or with minimal damage, and is conducive to separated sorting and filtering of the coating layer and/or leather fiber after stripping to allow special treatment.

It should be noted that the scheme of applying gas flow to the container in step S2 is basically the same as the arrangement scheme of the water jet, except that the water jet is replaced with a corresponding gas jet. The gas jet can inject high-pressure gas flow into the liquid in the container, thereby causing the liquid to vibrate and flow in a directional manner. In practical applications, gas flow and water flow may be simultaneously applied to the container in step S2, and a water jet and a gas jet may be simultaneously provided in the container in this case. Regarding the mechanical wave, it can generally only vibrate the liquid. In order to achieve the directional flow effect of liquid, a device for applying mechanical wave is generally used in conjunction with a water flow driving device. For example, an ultrasonic wave generator and a gas jet (or water jet) are installed in the container at the same time, and the gas jet or water jet mainly plays the role of driving the directional flow of liquid. Alternatively, while installing the ultrasonic wave generator in the container, a circulating water pump is also installed on the container to achieve driving the directional flow of liquid.

### Example 2

As shown in FIG. 2 to FIG. 9, this example provided a water stripping device of a leather fiber 100, which could be used to implement the water stripping method of a leather fiber in Example 1. Specifically, the water stripping device of a leather fiber 100 included a stripping container 1 and a liquid vibration device, where the stripping container 1 contained liquid, and the liquid was used to immerse a waste leather with a coating layer to be treated; the liquid vibration device was arranged on the stripping container 1 and immersed in the liquid in the stripping container 1. The liquid vibration device could apply at least one of water flow, gas flow, and mechanical wave to the stripping container 1 to vibrate the liquid, thereby stripping a leather fiber of the waste leather on the coating layer of the waste leather. Preferably, the liquid vibration device included a water jet 4, the water jet 4 was arranged in the stripping container 1 and immersed in the liquid in the stripping container 1, the water jet 4 was configured to spray the water flow into the liquid, and a jet direction of the water flow had an included angle of less than 90° with a liquid surface of the liquid to promote a directional flow of the liquid in the stripping container 1 while vibrating the liquid. The liquid might be water, or a chemical solution with a physical fiber-opening effect on the leather fiber of waste leather (with reference to Example 1). As a preferred solution, the liquid in the stripping container 1 was water.

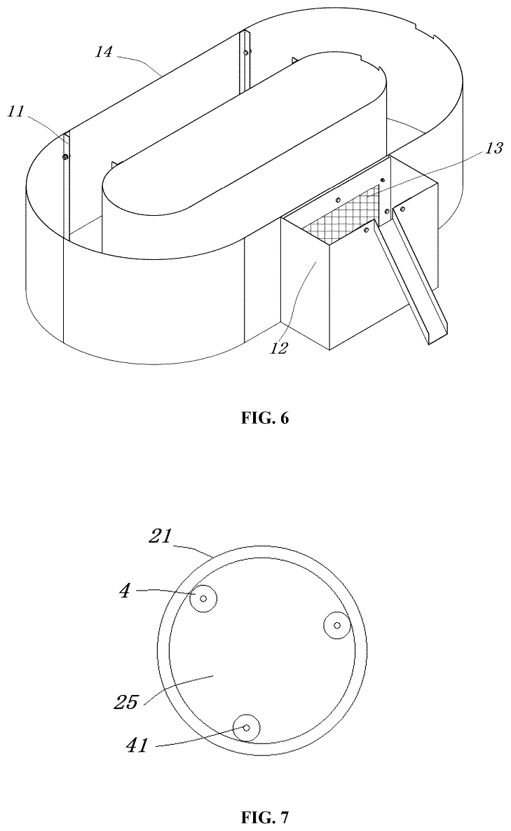

In this example, the water jet 4 was generally connected to an external water source through a high-pressure water pump 5. As the water in the stripping container 1 gradually increased, the stripping container 1 could be drained while the water jet 4 sprayed high-pressure water into the liquid. For example, a drainage structure was provided on the stripping container 1, and could be a traditional drainage port, and a drainage pipe and a drainage valve were connected to the drainage port, and a drainage rate and a drainage flow of the drainage port could be adjusted according to the water growth in the stripping container 1. Moreover, in order to prevent stripped leather fiber blocks from being discharged, a filter screen could be provided at the drainage port of the container to allow interception. In addition, the drainage structure might further include a filter plate 13 and a water tank with strainer 12. As shown in FIG. 2 and FIG. 6, a drainage port was provided on a side wall of the stripping container 1, the filter plate 13 was embedded in the drainage port, and the water tank with strainer 12 was provided on an outer wall of the drainage port, and the water tank with strainer 12 was connected to the drainage port. The filter plate 13 could not only intercept the leather fiber blocks, but also play a role in buffering the discharged water flow. A certain amount of water could be stored in the water tank with strainer 12, and the water in the stripping container 1 could be discharged by overflowing at a top of the water tank with strainer 12. As a preferred solution, the latter drainage structure was adopted in this example.

In addition to the above-mentioned solution of connecting to the external water source through the high-pressure water pump 5, in this example, the water jet 4 could also be connected to the water tank with strainer 12 of the stripping container 1 through the high-pressure water pump 5 and the liquid filtration device 6 in sequence, where the liquid filtration device 6 was configured to filter the liquid discharged from the stripping container 1, and the high-pressure water pump 5 was configured to pump the filtered liquid back to the water jet 4, thereby realizing cyclic injection of the liquid. The filter plate 13 and the liquid filtration device 6 successively filtered the water discharged from the stripping container 1 to ensure that the water reaching the high-pressure water pump 5 was free of impurities.

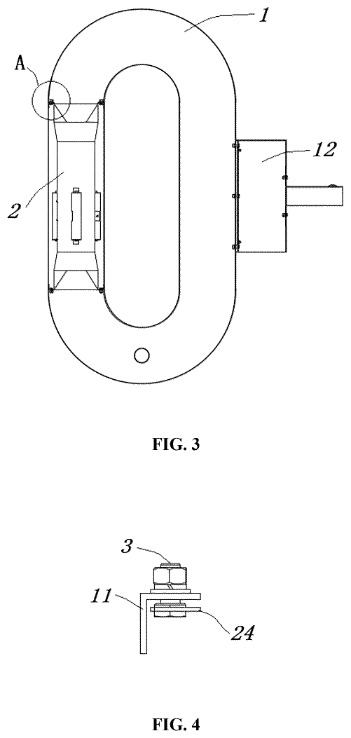

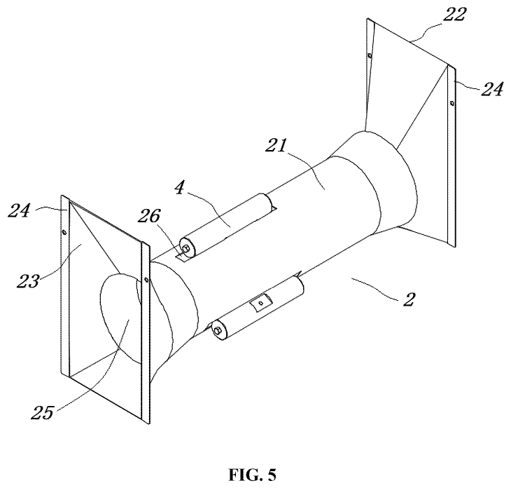

In this example, as shown in FIG. 2, FIG. 3, and FIG. 5, the stripping container 1 was preferably an annular flume 14 with an open top. The annular flume 14 was elliptical in shape, with straight sections on two sides and arc sections at both ends. A liquid circulation pressurizing pipe 2 was arranged in the straight section of the annular flume 14 along a directional flow direction of the liquid, the liquid circulation pressurizing pipe 2 was immersed in the liquid, an included angle between an axis of the liquid circulation pressurizing pipe 2 and a liquid surface of the liquid was less than 90°, the water jet 4 was embedded in a side wall of the liquid circulation pressurizing pipe 2 or arranged in the liquid circulation pressurizing pipe 2. An inner cavity of the liquid circulation pressurizing pipe 2 was a water passing zone 25 for liquid to flow through, and a liquid inlet end 22 and a liquid outlet end 23 of the liquid circulation pressurizing pipe 2 were both in a bell-mouth shape. Specifically, as shown in FIG. 5, a middle section 21 of the liquid circulation pressurizing pipe 2 was a straight pipe section, and axial ends of the middle section 21 were the liquid inlet end 22 and the liquid outlet end 23 in a bell-mouth shape, respectively. As shown in FIG. 3 and FIG. 4, outer contours of maximum ends of the liquid inlet end 22 and the liquid outlet end 23 were both rectangular shapes adapted to a groove shape of the annular flume 14, and an inner wall of the straight section of the annular flume 14 was provided with an L-shaped mounting plate 11, and the outer contours of the maximum ends of the liquid inlet end 22 and the liquid outlet end 23 were provided with an extension plate 24, and the liquid inlet end 22 and the liquid outlet end 23 of the liquid circulation pressurizing pipe 2 were both connected to the L-shaped mounting plate 11 on the inner wall of the annular flume 14 through the extension plate 24, and the extension plate 24 and the L-shaped mounting plate 11 were specifically connected by bolts 3.

The liquid circulation pressurizing pipe 2 was essentially a venturi tube structure with large ends and narrow in the middle. It was arranged in the directional flow direction of the liquid in the annular flume 14, which was equivalent to reducing a diameter of the liquid flow path in the annular flume 14. This was conducive to the rapid entry of the liquid into the liquid circulation pressurizing pipe 2 and could ensure the rapid ejection of the liquid in the liquid circulation pressurizing pipe 2. The liquid circulation pressurizing pipe 2 played a role in maintaining the water circulation direction and water circulation power in the annular flume 14 by adsorbing and pressurizing the water flow. A plurality of the liquid circulation pressurizing pipes 2 might be arranged at intervals along an annular direction of the annular flume 14.

In this example, the water jet 4 might be disposed outside the liquid circulation pressurizing pipe 2, or might be disposed on the liquid circulation pressurizing pipe 2. Preferably, the water jet 4 was integrated into the liquid circulation pressurizing pipe 2. Specifically as shown in FIG. 5, a mounting groove 26 was provided on a side wall of the middle section 21 of the liquid circulation pressurizing pipe 2, and the water jet 4 was embedded in the mounting groove 26, but a nozzle on the water jet 4 was located inside the middle section 21. The aforementioned middle section 21, the straight section of the annular flume 14, and the high-pressure water flow ejected by the nozzle were preferably arranged parallel to a water surface in the annular flume 14, that is, an included angle between the high-pressure water flow and the water surface was 0°. Moreover, an outer circumference of the middle section 21 was evenly spaced along its circumferential direction with multiple mounting grooves 26, and a water jet 4 was installed in any mounting groove 26, thereby forming a circumferential array of water jets in the middle section 21. A horizontal high-pressure water flow could be applied to the water in the water passing zone 25 to ensure the vibration and annular circulation of the water in the annular flume 14. When the multiple liquid circulation pressurizing pipes 2 were arranged in the annular flume 14, each of the multiple liquid circulation pressurizing pipes 2 might be provided with a group of the above-mentioned circular array of water jets. Each circular array of water jets shared a set of the high-pressure water pump 5 and liquid filtration device 6. In practical applications, the water jets 4 could be arranged at an angle in space, provided that the high-pressure water flow of the water jets 4 could provide sufficient power to drive the waste leather circulation. That is, the water jets 4 could be arranged at an angle relative to the water surface and an axial direction of the liquid circulation pressurizing pipe 2 at the same time, and multiple water jets 4 were evenly distributed in the circumferential direction of the liquid circulation pressurizing pipe 2, and the high-pressure water flows emitted by multiple water jets 4 could form a forward vortex. Thus, the waste leather could be driven to roll while driving the waste leather circulation, which helped to accelerate the decomposition of leather fiber.

It should be emphasized that in order to ensure that each water jet 4 on the liquid circulation pressurizing pipe 2 was immersed in water during operation, a water volume in the annular flume 14 should be sufficient to fill the middle section 21 with water when the water flowed through the middle section 21.

In this example, if the high-pressure water flow was arranged at an angle, an included angle between the high-pressure water flow and the water surface was preferably 20° to 85°.

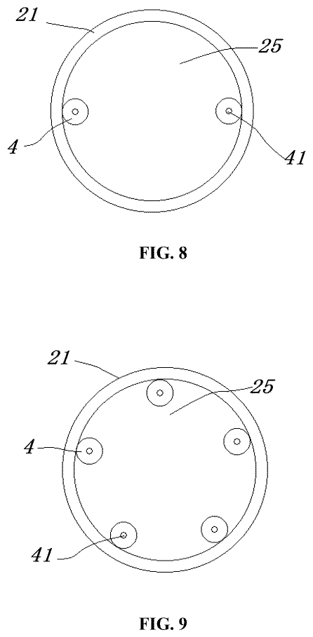

In practical applications, two, three, four, or five water jets 4 might be evenly distributed in the circumferential direction of the middle section 21 as required. Generally, the more water jets 4 were provided in the middle section 21, the fewer nozzles 41 could be provided on each water jet 4. As shown in FIG. 7, three water jets 4 were evenly arranged; as shown in FIG. 8, two water jets 4 were evenly arranged; as shown in FIG. 9, five water jets 4 were evenly arranged. Generally, the nozzle 41 had an inner diameter of 0.1 mm to 1 mm. The high-pressure water jetted by the water jet 4 had a pressure of generally 20 MPa to 200 MPa.

A working principle of the water stripping device of a leather fiber 100 of this example was described in detail below.

Each water jet 4 was connected to the water tank with strainer 12 of the annular flume 14 via a high-pressure water pump 5 and a liquid filtration device 6 in sequence. The waste leather with a coating layer after physical fiber opening was placed into the annular flume 14 according to a certain proportion. When the high-pressure water pump 5 was turned on, the water in the annular flume 14 could be vibrated by the horizontally ejected high-pressure water flow, and the water in the annular flume 14 could be driven to circulate in a directional manner along the annular flume 14. Moreover, the water in the annular flume 14 was continuously circulated inside and outside through the water jet 4, the high-pressure water pump 5, and the liquid filtration device 6, and the water flow rate of the internal and external circulation did not affect the directional circulation of the water in the annular flume 14. The above-mentioned submerged high-pressure water flow was used as a means of dissociating leather fibers. A cavitation effect generated by the high-pressure water flow underwater could achieve efficient stripping of the leather fiber on the coating layer without destroying (or less damaging) the coating layer, thus finally obtaining qualified fine leather fibers.

While utilizing the energized water to strip the leather fiber, the directional circulation flow of the water could drive the waste leather and the stripped leather fiber blocks to flow, making the force on the leather fiber more even, thereby preventing the waste leather and the leather fiber blocks from staying at the installation position of the water jet 4 and being over-impacted by the high-energy high-pressure water flow, avoiding the stripped leather fiber blocks to have too small a particle size.

In practical applications, after the water stripping work was completed, the fine leather fibers with a length of 5 mm to 7 mm or even longer in the annular flume 14 could be filtered, sorted, and recovered. In order to obtain fine leather fiber blocks that better met the requirements, a single treatment time of the waste leather in annular flume 14 could be extended, or a number of treatments of the leather fiber blocks could be increased (i.e., the stripped leather fiber was filtered out, sorted, and then put back into the annular flume 14 to allow secondary water impact crushing). In practical applications, the leather fiber could be filtered using a filtration device of corresponding specifications according to a required length.

Generally, the annular flume 14 was full of water (i.e., the water surface was flush with the annular flume 14 or slightly lower than the top of the annular flume 14). When the above-mentioned water stripping of leather fiber is conducted, the waste leather and the annular flume 14 had a proportional relationship, preferably 10 kg to 300 kg of waste leather per cubic meter of flume volume.

The water stripping device of a leather fiber 100 proposed in this example is used to allow water stripping of the leather fiber from the waste leather with a coating layer that has been physically opened. Compared with the prior art, there are the following beneficial effects:
I. Novel and reasonable structure: since a leather fiber in a waste leather is easier to be physically opened and impact-stripped than a coating layer, the waste leather with the coating layer can be initially treated by stripping, such that the leather fiber is effectively stripped from the coating layer. This process avoids the problem that the leather fiber and the coating layer cannot be separated due to adhesion, and even if the leather fiber and the coating layer are separated, broken leather fibers may still be doped with some coating layer fragments. Moreover, the process effectively improves an initial treatment effect of the waste leather and a leather fiber recovery rate, thereby improving a recycling rate of the waste leather with a coating layer and solving the problem of low recycling rate of the waste leather with a coating layer in the current market.
II. The method is conducted by immersing the waste leather in liquid. A working process is dust-free, and a working environment is safer and more environmental-friendly, thus avoiding the high safety risks such as explosion and flammability in the existing treatment of waste leather by mechanical shredding.
III. This method can effectively strip the leather fiber without damaging the coating layer or with minimal damage, and is conducive to separated sorting and filtering of the coating layer and/or leather fiber after stripping to allow special treatment.

### Example 3

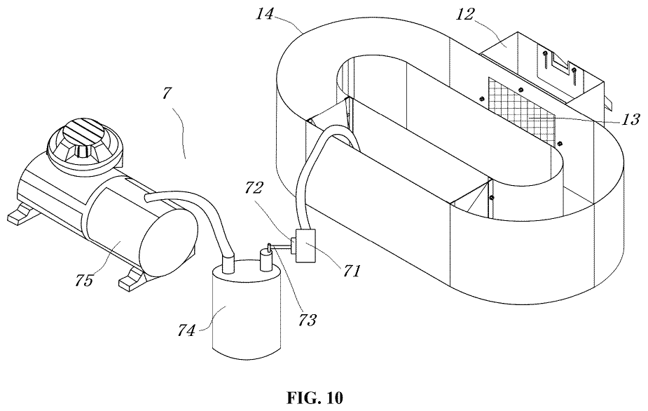

As shown in FIG. 10, this example proposed a water stripping device of a leather fiber 100, which differed from Example 2 only in that the liquid vibration device adopted a gas jet to replace the water jet 4. The gas jet had the same structure as that of the water jet 4, and the arrangement was also similar to that of the water jet 4 of Example 2. The gas jet differed from the water jet 4 only in that the gas jet needed to be connected to an external high-pressure gas source 7 when working, and the gas jet was used to spray high-pressure air into the liquid in the annular flume 14. Since no external water was added into the annular flume 14, the drainage structure in Example 2 might not be provided on the annular flume 14, and the side wall of the annular flume 14 was in a closed state.

In this example, the high-pressure gas source 7 included an air compressor 75, a gas storage tank 74, an impulse valve 72, an air cannon 71, and a gas guide tube 73. As shown in FIG. 10, the gas jet, the air cannon 71, the impulse valve 72, the gas storage tank 74, and the air compressor 75 were connected in sequence through the gas guide pipe 73. The high-pressure gas source 7 was in the prior art and did not be described in detail here. The air cannon 71 was also widely used in marine seismic exploration using existing equipment. It adopted an air gun to send high-pressure air into the water in a very short time to form air bubbles. The air bubbles oscillated alternately by expansion and contraction in the water, thereby driving the liquid to vibrate.

The gas jet ejected high-pressure gas flow into the liquid, which had substantially the same effect as ejecting high-pressure water flow into the liquid in Example 2, that is, the high-pressure gas flow could promote the directional circulation of the liquid in the annular flume 14 while vibrating the liquid. The high-pressure gas flow had a pressure of generally 0.2 MPa to 2 MPa.

A working principle of the water stripping device of a leather fiber 100 in this example was described in detail below.

Each gas jet was externally connected to a high-pressure gas source 7. The waste leather with a coating layer after physical fiber opening was placed into the annular flume 14 according to a certain proportion. By turning on the air cannon 71, the impulse valve 72, and the air compressor 75 of the high-pressure gas source 7, the water in the annular flume 14 could be vibrated by the horizontally ejected high-pressure gas flow, while the water in the annular flume 14 could be driven to circulate in a directional manner along the annular flume 14. The above-mentioned submerged high-pressure gas flow was used as a means of leather fiber dissociation, which could achieve efficient stripping of the leather fiber on the coating layer without destroying (or less damaging) the coating layer, thus finally obtaining qualified fine leather fiber fragments.

While utilizing the energized water to strip the leather fiber, the directional circulation flow of the water could drive the waste leather and the stripped leather fiber blocks to flow, making the force on the leather fiber more even, thereby preventing the waste leather and the leather fiber blocks from staying at the installation position of the gas jet and being over-impacted by the high-energy high-pressure gas flow, avoiding the stripped leather fiber blocks to have too small a particle size.

In practical applications, after the water stripping work was completed, the fine leather fibers with a length of 5 mm to 7 mm or even longer in the annular flume 14 could be sorted and recovered. In order to obtain fine leather fiber blocks that better met the requirements, a single treatment time of the waste leather in annular flume 14 could be extended, or a number of treatments of the leather fiber blocks could be increased (i.e., the stripped leather fiber was filtered out, sorted, and then put back into the annular flume 14 to allow secondary water impact crushing).

The water stripping device of a leather fiber 100 proposed in this example is used to allow water stripping of the leather fiber from the waste leather with a coating layer that has been physically opened. Compared with the prior art, there are the following beneficial effects:
I. Novel and reasonable structure: since a leather fiber in a waste leather is easier to be physically opened and impact-stripped than a coating layer, the waste leather with the coating layer can be initially treated by stripping, such that the leather fiber is effectively stripped from the coating layer. This process avoids the problem that the leather fiber and the coating layer cannot be separated due to adhesion, and even if the leather fiber and the coating layer are separated, broken leather fibers may still be doped with some coating layer fragments. Moreover, the process effectively improves an initial treatment effect of the waste leather and a leather fiber recovery rate, thereby improving a recycling rate of the waste leather with a coating layer and solving the problem of low recycling rate of the waste leather with a coating layer in the current market.
II. The method is conducted by immersing the waste leather in liquid. A working process is dust-free, and a working environment is safer and more environmental-friendly, thus avoiding the high safety risks such as explosion and flammability in the existing treatment of waste leather by mechanical shredding.
III. This method can effectively strip the leather fiber without damaging the coating layer or with minimal damage, and is conducive to separated sorting and filtering of the coating layer after stripping to allow special treatment.

### Example 4

This example proposed a water stripping device of a leather fiber 100, which differed from Examples 2 and 3 only in that the liquid vibration device adopted a mechanical wave transmitter and a liquid flow driving device, and the mechanical wave transmitter and the liquid flow driving device were both arranged in the stripping container 1. The mechanical wave transmitter was configured to spray mechanical waves into the liquid to make the liquid vibrate, and the liquid flow driving device could drive the liquid to flow in a directional manner in the stripping container 1 while the liquid vibrated.

In this example, the liquid flow driving device might adopt at least one of the water jet 4 in Example 2 and the gas jet in Example 3. When the liquid flow driving device was provided with the gas jet, the gas jet was provided on the liquid circulation pressurizing pipe 2 of the annular flume 14, the gas jet was configured to eject high-pressure gas flow into the liquid, and a jet direction of the high-pressure gas flow was less than 90° with a liquid surface of the liquid. When the liquid flow driving device was provided with the water jet 4, the water jet 4 was provided on the liquid circulation pressurizing pipe 2 of the annular flume 14, the water jet 4 was configured to eject high-pressure water flow into the liquid, and a jet direction of the high-pressure water flow was less than 90° with the liquid surface of the liquid. Generally, only one of the water jet 4 in Example 2 and the gas jet in Example 3 was required, and the structures, layouts, and operating principles of the water jet 4 and the gas jet could refer to Examples 2 and 3, respectively, and did not be described in detail here.

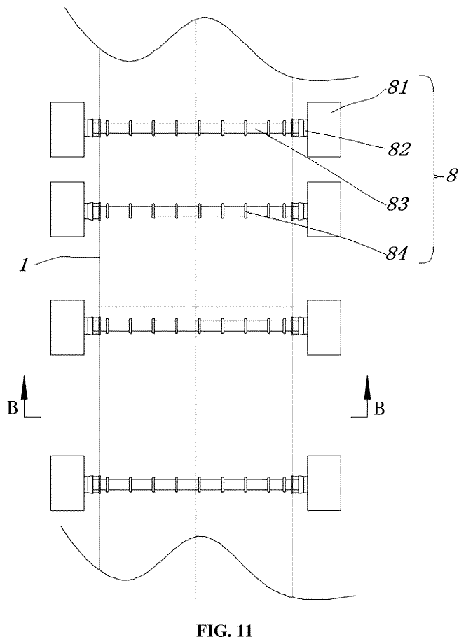

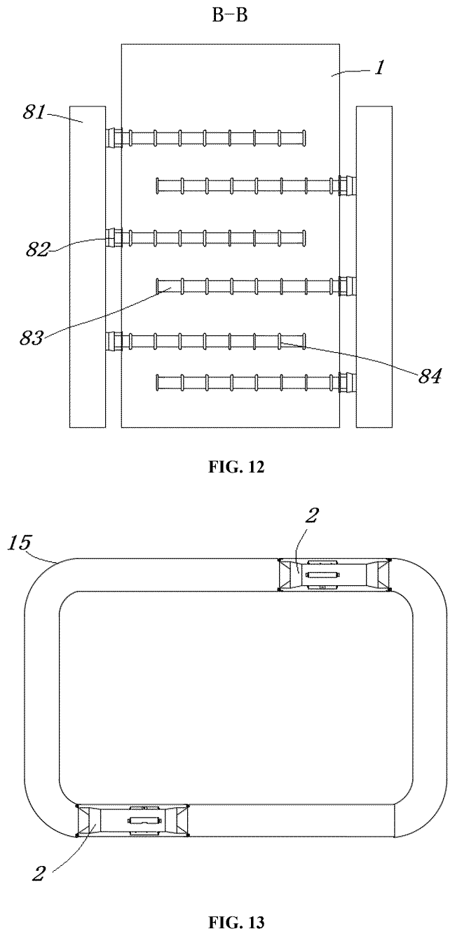

In this example, the mechanical wave transmitter was preferably an ultrasonic wave transmitting device 8, which was located in the annular flume 14 but outside the liquid circulation pressurizing pipe 2. Specifically, as shown in FIG. 11 and FIG. 12, the ultrasonic wave transmitting device 8 included multiple ultrasonic wave transmitting units, and any one of the ultrasonic wave transmitting units included an ultrasonic wave generator 81 and a vibration device, and the ultrasonic wave generator 81 was arranged on an outer wall of the annular flume 14. The vibration device included an amplitude transformer 82 and a vibrating arm 83, and the vibrating arm 83 was arranged in the annular flume 14 and immersed in the liquid. One end of the vibrating arm 83 penetrated a side wall of the annular flume 14 and was connected to the ultrasonic wave generator 81 through the amplitude transformer 82, and multiple protrusion structures 84 were arranged on the vibrating arm 83. The protrusion structure 84 was preferably a protrusion ring sleeved on the vibrating arm 83, and multiple protrusion rings were arranged on the vibrating arm 83 at intervals along an axial direction thereof.

In this example, multiple vibrating arms 83 could be preferably connected side by side on the same ultrasonic wave generator 81. As shown in FIG. 11, multiple ultrasonic wave transmitting units were distributed on an inner ring side wall and an outer ring of the annular flume 14, and the ultrasonic wave transmitting units on the inner ring side wall and the ultrasonic wave transmitting units on the outer ring side wall were arranged crosswise and staggered in a height direction of the annular flume 14. Based on this, the multiple ultrasonic wave transmitting units of the ultrasonic wave transmitting device 8 formed an ultrasonic wave vibration network on a longitudinal section of the annular flume 14, and gaps between any two adjacent vibrating arms 83 were used for the waste leather to pass through. The ultrasonic wave emitted by the ultrasonic wave generator 81 was transmitted to the vibrating arm 83, a vibration frequency of the vibrating arm 83 could generally reach 25 kHz to 100 kHz, cavitation air bubbles could be generated in the water, and a shock wave generated by the cavitation air bubbles could physically strip the leather fiber.

The following took the configuration of the water jet 4 disclosed in Example 2 in the annular flume 14 as an example to specifically describe a working principle of the water stripping device of a leather fiber 100 of this example.

Each water jet 4 was connected to the water tank with strainer 12 of the annular flume 14 via a high-pressure water pump 5 and a liquid filtration device 6 in sequence. The waste leather with a coating layer after physical fiber opening was placed into the annular flume 14 according to a certain proportion. By turning on each ultrasonic wave generator 81 to allow ultrasonic wave vibration on the water in the annular flume 14, and turning on the high-pressure water pump 5 to allow auxiliary vibration on the water in the annular flume 14, the water in the annular flume 14 could be driven to circulate along the annular flume 14 in a directional manner. Moreover, the water in the annular flume 14 was continuously circulated inside and outside through the water jet 4, the high-pressure water pump 5, and the liquid filtration device 6, and the water flow rate of the internal and external circulation did not affect the directional circulation of the water in the annular flume 14. The above-mentioned submerged ultrasonic wave vibration was used as a means of leather fiber dissociation, which could achieve efficient stripping of the leather fiber on the coating layer without destroying (or less damaging) the coating layer, thus finally obtaining qualified fine leather fiber fragments.

While utilizing the energized water to strip the leather fiber, the directional circulation flow of the water could drive the waste leather and the stripped leather fiber blocks to flow, making the force on the leather fiber more even, thereby preventing the waste leather and leather fiber blocks from staying at the installation position of the ultrasonic wave transmitting unit and being over-impacted by high-energy ultrasonic wave, avoiding the stripped leather fiber blocks to have too small a particle size.

In practical applications, after the water stripping work was completed, the fine leather fibers with a length of 5 mm to 7 mm or even longer in the annular flume 14 could be sorted and recovered. In order to obtain fine leather fiber blocks that better met the requirements, a single treatment time of the waste leather in annular flume 14 could be extended, or a number of treatments of the leather fiber blocks could be increased (i.e., the stripped leather fiber was filtered out, sorted, and then put back into the annular flume 14 to allow secondary water impact crushing).

The water stripping device of a leather fiber 100 proposed in this example is used to allow water stripping of the leather fiber from the waste leather with a coating layer that has been physically opened. Compared with the prior art, there are the following beneficial effects:
I. Novel and reasonable structure: since a leather fiber in a waste leather is easier to be physically opened and impact-stripped than a coating layer, the waste leather with the coating layer can be initially treated by stripping, such that the leather fiber is effectively stripped from the coating layer. This process avoids the problem that the leather fiber and the coating layer cannot be separated due to adhesion, and even if the leather fiber and the coating layer are separated, broken leather fibers may still be doped with some coating layer fragments. Moreover, the process effectively improves an initial treatment effect of the waste leather and a leather fiber recovery rate, thereby improving a recycling rate of the waste leather with a coating layer and solving the problem of low recycling rate of the waste leather with a coating layer in the current market.
II. The method is conducted by immersing the waste leather in liquid. A working process is dust-free, and a working environment is safer and more environmental-friendly, thus avoiding the high safety risks such as explosion and flammability in the existing treatment of waste leather by mechanical shredding.
III. This method can effectively strip the leather fiber without damaging the coating layer or with minimal damage, and is conducive to separated sorting and filtering of the coating layer after stripping to allow special treatment.

### Example 5

As shown in FIG. 13, this example provided a water stripping device of a leather fiber 100, which was differed from Examples 2, 3, and 4 only in that the stripping container 1 was a square annular flume 15.

### Example 6

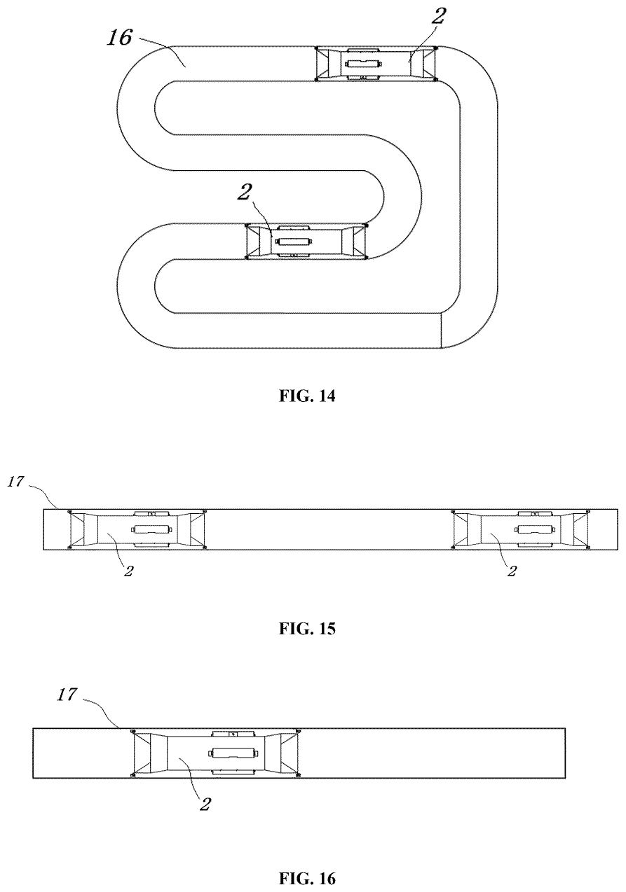

This example provided a water stripping device of a leather fiber 100, which was differed from Examples 2, 3, 4, and 5 only in that the stripping container 1 was a multi-cambered flume 16. The multi-cambered flume 16 could be a curved flume, or a closed-loop curved flume shown in FIG. 14.

### Example 7

This example provided a water stripping device of a leather fiber 100, which was differed from Examples 2, 3, 4, 5, and 6 only in that the stripping container 1 was a straight flume 17. As shown in FIG. 15, a liquid circulation pressurizing pipe 2 was provided at both ends of the straight flume 17, respectively, and each liquid circulation pressurizing pipe 2 could be installed with a water jet 4 or a gas jet, and the water jet 4 or gas jet on the two liquid circulation pressurizing pipes 2 were arranged opposite to each other. The jets on the two liquid circulation pressurizing pipes 2 were turned on alternately intermittently, such that the water in the straight flume 17 could flow back and forth in a straight manner.

As shown in FIG. 16, a liquid circulation pressurizing pipe 2 was set in the straight flume 17 and arranged close to one end of the straight flume 17. A water jet 4 or a gas jet was installed on the liquid circulation pressurizing pipe 2 to realize the unidirectional linear flow of water in the straight flume 17. Based on this structure, it was generally necessary to increase a number of treatments for the leather fiber blocks, that is, the stripped leather fiber blocks were filtered out and then put back into the straight flume 17 to allow secondary water-impacted shredding.

### Example 8

This example provided a water stripping system of a leather fiber, including the water stripping devices of a leather fiber 100 in any one of Examples 2 to 8. This system was generally equipped with a pool or a trough for preliminary physical fiber opening of the waste leather. The pool or the trough was filled with the chemical solution in Example 1, such that the preliminary physical fiber opening of the waste leather could be achieved by immersing the waste leather.

### Example 9

This example proposed a water stripping system of a leather fiber, which was further configured with a filtration device on the basis of Example 8, and the filtration device was configured to filter the leather fiber fragments stripped from the stripping container 1.

Specific examples are used for illustration of the principles and implementations of the present disclosure. The description of the above examples is merely used to help understand the method and its core ideas of the present disclosure. In addition, those of ordinary skill in the art can make modifications in terms of specific implementations and scope of use according to the ideas of the present disclosure. In conclusion, the content of the present specification shall not be construed as limitations to the present disclosure.

What is claimed is:

1. A water stripping method of a leather fiber, comprising the following steps:
S1, immersing a waste leather with a coating layer in a chemical solution to achieve preliminary immersing and softening of a leather fiber of the waste leather; and
S2, immersing the waste leather after the preliminary immersing and softening in a container filled with a liquid, and applying at least one selected from the group consisting of a water flow, a gas flow, and a mechanical wave to the liquid in the container, such that the liquid in the container impacts the waste leather after the preliminary immersing and softening and then strips the leather fiber on the coating layer of the waste leather.

2. The water stripping method of a leather fiber according to claim 1, wherein the chemical solution is at 20° C. to 80° C. , the waste leather is immersed in the chemical solution for a time t greater than or equal to 1 h and less than or equal to 24 h, and a content K of the waste leather in the chemical solution is less than or equal to 300 kg/cubic meter of the chemical solution in step S1.

3. The water stripping method of a leather fiber according to claim 1, wherein the chemical solution comprises water and a biological protease, and the chemical solution has a pH value of 2 to 11.

4. The water stripping method of a leather fiber according to claim 3, wherein the biological protease is at least one selected from the group consisting of a serine protease and an alkaline protease.

5. The water stripping method of a leather fiber according to claim 3, wherein the liquid in step S2 is selected from the group consisting of water and the chemical solution.

6. A water stripping device of a leather fiber, comprising:
a stripping container (1), wherein the stripping container (1) contains a liquid, and the liquid is configured to immerse a waste leather with a coating layer; and
a liquid vibration device arranged on the stripping container (1) and immersed in the liquid, wherein the liquid vibration device is configured to apply at least one selected from the group consisting of a water flow, a gas flow, and a mechanical wave to the liquid in the stripping container (1), such that the liquid impacts the waste leather and then strips a leather fiber of the waste leather on the coating layer of the waste leather.

7. The water stripping device of a leather fiber according to claim 6, wherein the liquid vibration device comprises a water jet (4), the water jet (4) is arranged in the stripping container (1), the water jet (4) is configured to spray the water flow into the liquid, and a jet direction of the water flow has an included angle of less than 90° with a liquid surface of the liquid to promote a directional flow of the liquid in the stripping container (1) while vibrating the liquid.

8. The water stripping device of a leather fiber according to claim 7, wherein the water jet (4) is connected to an external water source via a high-pressure water pump (5); alternatively, the water jet (4) is connected to the stripping container (1) via the high-pressure water pump (5) and a liquid filtration device (6); the liquid filtration device (6) is configured to filter the liquid in the stripping container (1), and the high-pressure water pump (5) is configured to pump a resulting filtered liquid to the water jet (4), thereby achieving cyclic injection of the liquid.

9. The water stripping device of a leather fiber according to claim 6, wherein the liquid vibration device comprises a gas jet, the gas jet is arranged in the stripping container (1), the gas jet is configured to spray the gas flow into the liquid, and a jet direction of the gas flow has an included angle of less than 90° with a liquid surface of the liquid to promote a directional flow of the liquid in the stripping container (1) while vibrating the liquid.

10. The water stripping device of a leather fiber according to claim 9, wherein the gas jet is externally connected to a high-pressure gas source (7).

11. The water stripping device of a leather fiber according to claim 7, wherein a liquid circulation pressurizing pipe (2) is arranged in the stripping container (1) along a direction of the directional flow of the liquid, and the liquid circulation pressurizing pipe (2) is immersed in the liquid to allow the liquid to flow through; an axis of the liquid circulation pressurizing pipe (2) has an included angle of less than 90° with the liquid surface of the liquid; and the liquid vibration device is embedded in a side wall of the liquid circulation pressurizing pipe (2), or arranged in the liquid circulation pressurizing pipe (2), or arranged in front of a liquid inlet end (22) of the liquid circulation pressurizing pipe (2), and the liquid inlet end (22) is in a bell-mouth shape.

12. The water stripping device of a leather fiber according to claim 11, wherein a liquid outlet end (23) of the liquid circulation pressurizing pipe (2) is in a bell-mouth shape.

13. The water stripping device of a leather fiber according to claim 6, wherein the liquid vibration device comprises a mechanical wave transmitter and a liquid flow driving device, the mechanical wave transmitter and the liquid flow driving device each are arranged in the stripping container (1), the mechanical wave transmitter is configured to spray the mechanical wave into the liquid to make the liquid vibrate, and the liquid flow driving device is configured to drive a directional flow of the liquid in the stripping container (1) while the liquid vibrates.

14. The water stripping device of a leather fiber according to claim 13, wherein the liquid flow driving device comprises at least one of a gas jet and a water jet (4); when the liquid flow driving device is the gas jet, the gas jet is arranged in the stripping container (1), the gas jet is configured to spray the gas flow into the liquid, and a jet direction of the gas flow has an included angle of less than 90° with a liquid surface of the liquid; and
when the liquid flow driving device is the water jet (4), the water jet (4) is arranged in the stripping container (1), the water jet (4) is configured to spray the water flow into the liquid, and a jet direction of the water flow has an included angle of less than 90° with the liquid surface of the liquid.

15. The water stripping device of a leather fiber according to claim 13, wherein the mechanical wave transmitter is an ultrasonic wave transmitting device (8).

16. The water stripping device of a leather fiber according to claim 15, wherein the ultrasonic wave transmitting device (8) comprises multiple ultrasonic wave transmitting units, and any one of the multiple ultrasonic wave transmitting units comprises:
an ultrasonic wave generator (81) arranged on an outer side wall of the stripping container (1); and
a vibration device comprising an amplitude transformer (82) and a vibrating arm (83), wherein the vibrating arm (83) is arranged in the stripping container (1) and immersed in the liquid, an end of the vibrating arm (83) is connected to the ultrasonic wave generator (81) through the amplitude transformer (82), and multiple protrusion structures (84) are arranged on the vibrating arm (83).

17. The water stripping device of a leather fiber according to claim 6, wherein the stripping container (1) is selected from the group consisting of an annular flume, a multi-cambered flume (16), and a straight flume (17).

18. A water stripping system of a leather fiber, comprising a filtration device and the water stripping device of a leather fiber (100) according to any one of claim 6, wherein the filtration device is configured to filter the leather fiber stripped from the stripping container (1).

19. The water stripping method of a leather fiber according to claim 2, wherein the chemical solution comprises water and a biological protease, and the chemical solution has a pH value of 2 to 11.

20. The water stripping device of a leather fiber according to claim 8, wherein a liquid circulation pressurizing pipe (2) is arranged in the stripping container (1) along a direction of the directional flow of the liquid, and the liquid circulation pressurizing pipe (2) is immersed in the liquid to allow the liquid to flow through; an axis of the liquid circulation pressurizing pipe (2) has an included angle of less than 90° with the liquid surface of the liquid; and the liquid vibration device is embedded in a side wall of the liquid circulation pressurizing pipe (2), or arranged in the liquid circulation pressurizing pipe (2), or arranged in front of a liquid inlet end (22) of the liquid circulation pressurizing pipe (2), and the liquid inlet end (22) is in a bell-mouth shape.
